(19) United States
(12) Patent Application Publication
(10) Pub. No.: US 2012/0261890 A1
(43) Pub. Date: Oct. 18, 2012

(54) PRESSURE SEAL

(76) Inventors: David C. Hageman, Chagrin Falls, OH (US); Richard L. Dudman, Euclid, OH (US); Timothy M. Herda, Madison, OH (US); Brian Christopher Biller, Mentor, OH (US)

(21) Appl. No.: 13/424,863

(22) Filed: Mar. 20, 2012

Related U.S. Application Data
(60) Provisional application No. 61/476,467, filed on Apr. 18, 2011.
(60) Provisional application No. 61/552,103, filed on Oct. 27, 2011.

(51) Int. Cl. F16J 15/10

(52) U.S. Cl. 277/638

(57) ABSTRACT

A pressure seal assembly for sealing a bonnet assembly that is removably received by an access port defined by a body portion of a high pressure control device. The seal assembly inhibits leakage between the body portion and the bonnet assembly and includes an annular graphite gasket having a tapered portion defining an angled surface engageable with a complementally-formed surface on the bonnet assembly. A first anti-extrusion ring is urged into sealing engagement with a surface defined by the access port. A pair of inner and outer anti-extrusion rings are urged into sealing contact with an access port surface and bonnet surface. The bonnet assembly includes a reduced diameter section which defines a seal assembly receiving cavity. The anti-extrusion rings include overlapped ends, which allow expansion and contraction while maintaining overlapping contact. Camming surfaces may include retaining segments which maintain the inner and outer extrusion rings in an assembled relation.

### RELATED APPLICATIONS

This application claims priority from U.S. Provisional Application Ser. No. 61/476,467, filed Apr. 18, 2011; and U.S. Provisional Application Ser. No. 61/552,103, filed Oct. 27, 2011, the subject matter of which is incorporated herein in its entirety.

### TECHNICAL FIELD

The present invention relates generally to sealing and, in particular, to a seal assembly for use in a high pressure control device such as a pressure seal valve.

### BACKGROUND

Pressure seal valves are commonly used in high pressure applications such as steam generation. These valves not only must operate at high pressures, but also at high temperatures. Special high pressure seals are often used to inhibit working fluid leakage past a bonnet assembly that usually forms part of these types of devices.

### SUMMARY OF THE INVENTION

The present invention provides a new and improved seal assembly and method of sealing for use in high pressure control devices such as pressure seal valves of the type that are often used in steam generation.

According to one embodiment of the invention, a pressure seal assembly for use in a high pressure control device is disclosed. The seal assembly includes an annular graphite gasket having an angled seal surface that is sealingly engageable with a complementally-formed first sealing surface defined on a bonnet assembly that forms part of the control device. A pair of anti-extrusion rings are spaced from the sealing surface. One of the pair of anti-extrusion rings is sealingly engageable with a second surface on the bonnet assembly, the other of the anti-extrusion rings is sealingly engageable with a surface defined by an access bore forming part of the control device. The anti-extrusion rings inhibit the flow of gasket material past the rings. A third anti-extrusion ring is located in the vicinity of the bonnet sealing surface and is sealingly engageable with the access bore surface. The engagement of the bonnet sealing surface by the third anti-extrusion ring inhibits the flow of graphite material past the third ring.

In one illustrated embodiment, camming surfaces are used for urging at least some of the anti-extrusion rings into sealing contact with their associated surfaces. In a more preferred embodiment, the camming surfaces are formed in the annular graphite gasket. In an alternate embodiment, the camming surfaces are formed on a thrust member that abutably engages the annular graphite gasket.

In still another embodiment, the camming surfaces are formed on the annular graphite gasket and includes segments that abutably engage the pair of anti-extrusion rings prior to installation of the seal assembly. These segments maintain the assembled relationship of the pair of anti-extrusion rings and the annular graphite gasket, which facilitates installation.

According to a feature of the invention, the seal assembly comprises an annular graphite gasket defining an angled seal surface sealingly engageable with a complementally-shaped sealing surface formed on a bonnet that forms part of the control device and which is used to cap or close off a bore in the device. A pair of radially spaced apart anti-extrusion wire rings inhibit graphite migration out of a seal region. Angled surfaces on the graphite gasket urge these wire rings into sealing engagement with the bonnet and bore structure. Another anti-extrusion wire ring, preferably larger in diameter than the aforementioned wire rings, inhibits graphite migration into a working fluid (i.e. steam) region of the control device, the region that is sealed off by the bonnet.

According to the invention, when compression forces are applied to the seal assembly of the present invention, the anti-extrusion rings are urged into “sealing” engagement with associated surfaces and the graphite material itself is deformed or “flows” plastically to fill voids in the sealing cavity. The gasket material does not otherwise gall or damage the bonnet or bore surfaces and, hence, disassembly for service is greatly facilitated.

According to another aspect of the invention, a high pressure control assembly is disclosed that includes a body portion defining an access port. A bonnet assembly is removably received by the body for at least partially closing off the access port. A seal assembly inhibits leakage between the body portion and the bonnet assembly includes an annular graphite gasket. The annular gasket includes a tapered portion defining an angled surface engageable with a complementally-formed angled surface on the bonnet assembly. A first anti-extrusion ring associated with the tapered portion of the annular graphite seal is urged into sealing engagement with a surface defined by the access port, when a clamping pressure is applied to the annular graphite gasket. A pair of inner and outer anti-extrusion rings, one of which being associated with an outer diameter of the annular graphite gasket, the other of which being associated with an inner diameter of the annular graphite gasket, are urged into sealing contact with the access port surface and the associated bonnet assembly surface, respectively. These rings are urged into sealing engagement with their respective surfaces when a clamping force is applied to the annular graphite gasket. in one illustrated embodiment, the bonnet assembly includes a reduced diameter section which at least partially defines a seal assembly receiving cavity between the bonnet assembly and the body portion.

The term “sealing” used in connection with the anti-extrusion rings describes contact between the rings and associated surfaces that is sufficient to inhibit leakage of graphite material past the rings. The “sealing” engagement of the rings is not intended to necessarily prevent leakage of fluid (i.e., steam) out of the working fluid region. The graphite based gasket provides this sealing function.

According to a feature of the invention, the ant-extrusion wire rings are split, the ends of which are joined using a lap joint such as a shiplap joint. The joint allows a given wire ring to expand or contract radially but inhibits leakage of graphite gasket material between the joined ends.

Additional features of the invention will become apparent and a fuller understand obtained by reading the following detailed description made in connection with the accompanying drawings.

### BRIEF DESCRIPTION OF THE DRAWINGS

FIG. 1 is a fragmentary sectional view of a portion of a high pressure control assembly that utilizes a high pressure seal constructed in accordance with a preferred embodiment of the invention;

FIG. 2 is a fragmentary sectional view showing the seal of the present invention in a relaxed position;

FIG. 3 is a fragmentary sectional view showing the seal of the present invention in a fully installed position

FIG. 4 illustrates the configuration of a lap joint that forms part of anti-extrusion wire rings constructed in accordance with a preferred embodiment of the invention;

FIG. 5 is a fragmentary sectional view showing an alternate embodiment of the seal of the present invention in a relaxed position; and

FIG. 6 is a fragmentary sectional view showing another alternative embodiment of the seal of the present invention, shown in a relaxed position.

### DETAILED DESCRIPTION

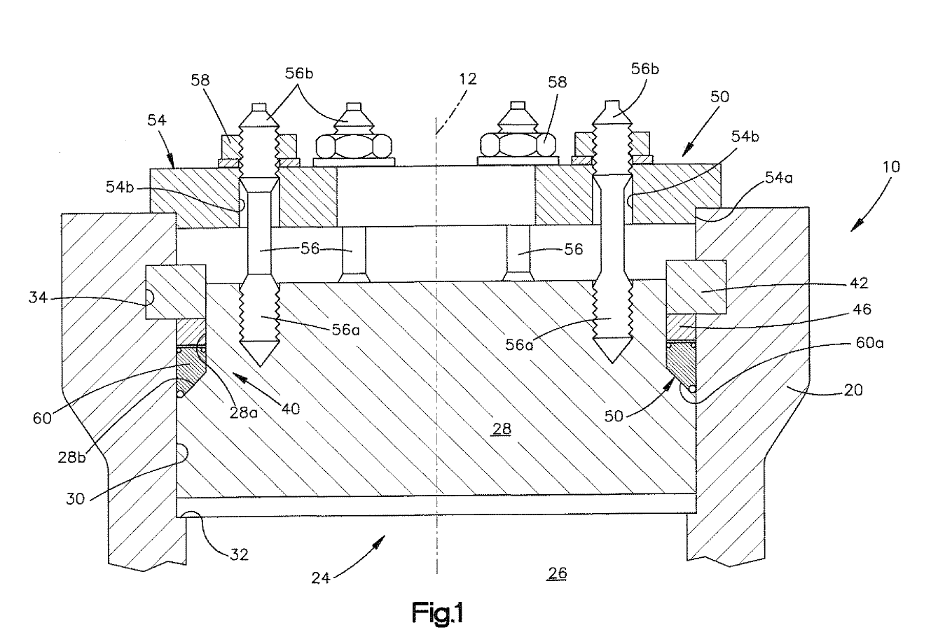

FIG. 1 is, a fragmentary sectional view showing a method and apparatus for sealing a bonnet assembly in a control device 10 that is used in high pressure fluid applications such as steam generation. The device 10 to which this invention pertains may be what is termed a pressure seal valve, of which there are several varieties including a globe valve, a gate valve or a tilt disc valve. The structure shown in FIG. 1 may be used as a port for gaining access to valve components, or, alternatively, the structure may operatively mount a valve actuating mechanism by which a valving element (not shown) is opened or closed. Those skilled in the art will recognize that the structure shown in FIG. 1 may be used to sealingly support, for example, a valve operating stem which would extend along the centerline 12 and which would be attached to an operating member at its upper end (as viewed in FIG. 1) and a valving component at its lower end.

To facilitate the explanation, the structure in FIG. 1 will be described as an access port, which includes a port or valve body 20. As should be apparent, the body 20 extends downwardly and includes a housing that encloses valving or other components. The portion of the body shown in FIG. 1 provides access to the components when a bonnet assembly indicated generally by the reference character 24 is removed. In general, the region below the bonnet assembly indicated by the reference character 26 is generally at extremely high pressure and may also be at high temperature. A typical application for the device shown in FIG. 1 is in a steam generation facility.

The device body 20 may include a stepped bore 30, which defines a lower step 32 and an annular recess 34. A bonnet 28 acts as a closure for the bore 30. A sealing arrangement indicated by the reference character 40 seals the bonnet 24a to the bore 30 and inhibits leakage of high pressure fluid from the region 26 to the outside ambient.

As is conventional the bonnet 28 defines a reduced diameter section 28a, which defines a gap between the bonnet, 28a and the body bore 30; the gap receives the sealing arrangement 40. A conventional segmented ring 42 is captured between the reduced diameter section 28a, of the bonnet 28 and the annular recess 34 defined by the body 20. The segmented ring 42 acts a retainer for the bonnet 28 and maintains its position within the body bore 30.

In the illustrated construction, a backing ring 46 is located below the segmented ring 42 and is used to apply compression forces to a seal assembly 50 constructed in accordance with a preferred embodiment of the invention. The upper end of the body 20 receives a retaining cap 54, that includes a reduced diameter section 54a, which is receivable by the body bore 30. A plurality of bonnet clamping studs 56 have lower ends 56a threadedly received by the bonnet 28 and a threaded upper end which extends through bores 54b formed in the retaining cap and which threadedly receive fasteners such as nuts 58. The nuts 58 apply tension forces to the retaining studs 56. As should be apparent from FIG. 1, the bonnet 28 and associated seal components are placed in the body bore and the bonnet is lowered until it sits atop the body step 32. In this position, sufficient clearance is provided to insert the segmented ring 42. The clamping studs 56 are then threaded into the bonnet 28. The retaining cap 54 is then aligned with and then placed on the upper end of a valve body 20 allowing the studs 56 to extend through the bores 54b. The nuts 58 are then threaded onto the upper ends 56b of the studs 56 and are tightened in order to pull the bonnet assembly upwardly until the backing ring 46 contacts the underside of the segment ring 34 thereby applying compression forces to the seal assembly 50.

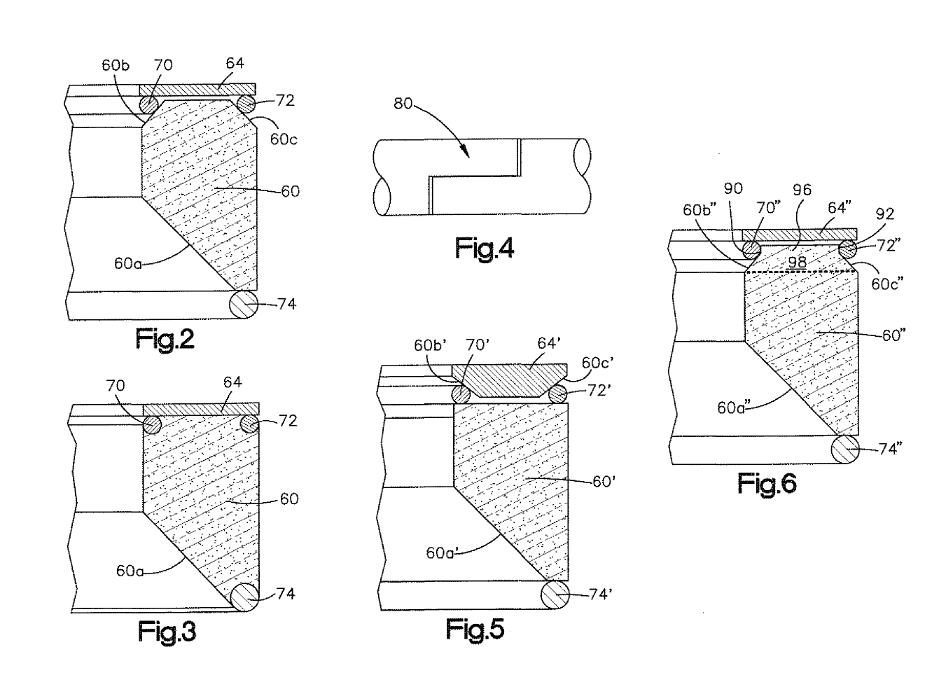

Turning also to FIGS. 2 and 3, the construction and operation of the seal assembly 50 will now be described. According to the invention, the seal assembly 50 includes a shaped graphite ring or gasket 60 that, in the preferred embodiment, includes a lower angled surface 60a. The surface is configured to conform to an angled seal surface 28b formed on the bonnet 28. In the preferred and illustrated embodiment, the graphite gasket 60 has a density of 0.8 grams of graphite per cubic centimeter or higher.

The seal assembly includes a pair of upper anti-extrusion wire rings 70, 72 and a lower anti-extrusion wire ring 74 which inhibit the flow or migration of graphite when under pressure, out of the seal cavity defined between the backing ring 46 and the bonnet sealing surfaces. In the preferred and illustrated embodiment, the lower anti-extrusion ring is of a larger wire diameter than the upper rings. In the preferred and illustrated embodiment, the seal assembly also includes an annular thrust plate 64 that sits atop the two upper anti-extrusion wire rings 70, 72.

FIG. 2 illustrates the configuration and shape of the graphite seal element 60 prior to the application of compression forces by the clamping studs 56. As seen in FIG. 2, the upper portion of the graphite seal 60 includes angled surfaces 60b, 60c that are contacted by associated anti-extrusion rings. During compression, this angled surface 60a urges the inner anti-extrusion ring 70 radially inwardly and the outer anti-extrusion wire ring 72 radially outwardly. Thus, the inner anti-extrusion ring 70 is urged into sealing engagement with the reduced diameter section 28a of the bonnet 28 and the underside of the thrust ring 64. The outer anti-extrusion wire ring 72 is urged into sealing contact with the body bore 30 and the underside of the thrust plate 64.

During compression the lower anti-extrusion wire ring 74 is urged radially outwardly and thus sealingly engages the body bore 30 and the angled bonnet sealing surface 28b and thus inhibits the flow or migration of graphite out of the sealing region and into the interface between the bonnet 28 and the body bore 30. FIG. 3 illustrates the configuration of the graphite seal and the position of the anti-extrusion wire rings after the predetermined and desired clamping force is applied to the bonnet 28 by the clamping studs 56.

In the preferred and illustrated embodiment, each extrusion ring is slit to enable the rings to expand and contract radially during installation then compression of the graphite seal. Referring to FIG. 4, this feature is achieved by lapping the ends of each extrusion ring as shown to form a joint 80 that allows the ends of the wire ring to slide relative to each other as the ring contacts or expands radially. The illustrated “shiplap” joint 80 inhibits the flow or extrusion of graphite between the ends of an extrusion ring while allowing relative movement between the ends. Other types of overlapping joints for the wire ring ends can be used and are contemplated by the present invention.

FIG. 5 illustrates an alternate embodiment for the seal assembly in which the camming or angled surfaces for urging the upper anti-extrusion rings (as viewed in FIG. 5) into sealing engagement with associated surfaces is provided by a thrust ring 64′. In particular, the thrust ring 64′ includes annular, angled or camming surfaces 60b′ and 60c′. The surface 60b′ urges the associated anti-extrusion ring 70′ radially inwardly into graphite sealing contact with the reduced diameter surface 28a of the bonnet 28 and the camming surface 60c′ urges the associated anti-extrusion ring 72′ radially outwardly into sealing contact with the bore surface 30. The surfaces 60b′ and 60c′ formed on the thrust ring 64′ provide the same function as the annular angled surfaces 60b, 60c formed on the graphite gasket 60 (shown in FIG. 2).

FIG. 6 shows still another embodiment of the invention. In this embodiment, a graphite ring 60″ includes angled or camming surfaces 60b″, 60c″ for urging respective anti-extrusion rings 70″, 72″ into sealing contact with a reduced diameter section 28a of the bonnet 28 (shown in FIG. 1) and with the body bore 30 (also shown in FIG. 1), respectively. Unlike the FIG. 2 embodiment, the angled or surfaces 60b″, 60c″ terminate at their upper ends (as viewed in FIG. 6) in respective vertical segments 90, 92. Together, the vertical segments 90, 92 define a section 96 of the seal 60″ having a uniform cross-section that is immediately adjacent a portion 98 having a tapered cross-section as defined by the angled surfaces 60b″, 60e″. The vertical segments 90, 92 aid in the retention of the anti-extrusion rings 70″, 72″, respectively, during assembly, transport and seal installation. As seen in FIG. 6, the vertical segments 90, 92 have sufficient heights such that an upper edge of each vertical segment contacts its respective anti-extrusion ring at or above its midpoint.

With the disclosed embodiment, the angled surfaces 60b″, 60c″ urge the respective anti-extrusion rings radially inwardly and radially outwardly, respectively as compression forces are exerted by the clamping studs 56 (see FIG. 1). After a predetermined and desired clamping force is applied to the bonnet 28, the graphite seal and the anti-extrusion wire rings 70″, 72″ assume a configuration and positions substantially similar to that shown in FIG. 3. Plastic flow occurs in the graphite seal 60″ such that it fills the void in the seal region just as the seal element 60 shown in FIG. 3.

With the disclosed alternate embodiment, assembly, shipping and installation of the graphite seal with associated anti-extrusion rings is greatly facilitated. In addition, the alternate embodiment of the invention permits the construction of seal elements 60″ with smaller cross sections. In other words, the seal construction of the alternate embodiment shown in FIG. 6 contains all of the advantages of the construction of the seal shown in FIG. 2, with several additional advantages.

With the present invention, an extremely effective seal between the bonnet 28 and a high pressure device body can be achieved while allowing easy disassembly when repair or service of the device is needed. Unlike prior art metal gaskets, the seal of the present invention does not gall or damage the sealing surfaces, which, in prior art devices, makes disassembly very difficult.

Although the invention has been described with a certain degree of particularity, those skilled in the art will recognize that various changes can be made to it without departing from the spirit or scope of the invention as hereinafter claimed.

Having described the invention, the following is claimed:

1. A pressure seal assembly for use in a high pressure control device, comprising:
a) an annular graphite gasket having an angled sealing surface, said surface sealingly engageable with a complementally-formed first sealing surface defined on a bonnet assembly forming part of the control device;
b) a pair of anti-extrusion rings spaced from said sealing surface, one of said anti-extrusion rings sealingly engageable with a second surface on said bonnet assembly, the other of said anti-extrusion rings sealing engageable with a surface on an access bore forming part of said control device, whereby said anti-extrusion rings inhibit the flow of gasket material past said rings;
c) a third anti-extrusion ring located in the vicinity of said bonnet sealing surface and sealingly engageable with said access bore surface, whereby flow of said graphite material past said third article-extension ring is inhibited.

2. The pressure seal assembly of claim 1 further including camming surfaces for urging at least some of said anti-extrusion rings into sealing contact with their associated surfaces.

3. The sealing assembly of claim 2 wherein said camming surfaces are formed in said annular graphite gasket.

4. The gasket assembly of claim 2 wherein said camming surfaces are formed on a thrust member that abutably engages said annular graphite gasket.

5. The seal assembly of claim 1 further including camming surfaces formed on said annular graphite gasket, said camming surfaces associated with said pair of anti-extrusion rings, one of said anti-extrusion rings urged into sealing contact with said access bore surface, the other of said anti-extrusion rings urged into sealing contact with said bonnet assembly surface.

6. The pressure seal assembly of claim 1 wherein said bonnet assembly sealing surface is cylindrical.

7. The sealing assembly of claim 5 wherein said camming surfaces include segments that abutably engage said pair of anti-extrusion rings prior to installation of said seal assembly, whereby the assembled relation of said pair of anti-extrusion rings and said annular graphite gasket is maintained.

8. A high pressure control assembly, comprising:
a) a body portion defining an access port;
b) a bonnet assembly removably received by said body for at least partially closing off said access port;
c) a seal assembly for inhibiting leakage between said body portion and said bonnet assembly, said seal assembly including:
i) an annular graphite gasket, said annular gasket including a tapered portion defining an angled surface engageable with a complementally-formed angled surface on said bonnet assembly;
ii) a first anti-extrusion ring associated with said tapered portion of said annular graphite gasket, said first anti-extrusion ring being urged into sealing engagement with a surface defined by said access port, when clamping pressure is applied to said annular graphite gasket;
iii) a pair of inner and outer anti-extrusion rings, one of which being associated with an outer diameter of said annular graphite gasket, the other of which being associated with an inner diameter of said annular graphite seal, said one anti-extrusion ring being urged into sealing contact with said access port surface and said other anti-extrusion ring being urged into sealing engagement with an associated surface on said bonnet assembly, when a clamping force is applied to said annular graphite gasket.

9. The control device of claim 8 wherein said bonnet assembly includes a reduced diameter section which at least partially defines a seal assembly receiving cavity between said bonnet assembly and said body portion.

10. The control device of claim 8 wherein said inner and outer anti-extrusion rings are urged into sealing contact with their associated surfaces by camming surfaces defined by said annular graphite gasket.

11. The control device of claim 8 wherein at least one of said anti-extrusion rings includes overlapped ends which allow said one anti-extrusion ring to expand and contract radially while maintaining a sealing contact between said ends of said anti-extrusion ring when said seal assembly is fully installed.

12. The control device of claim 8 wherein said assembly further includes a thrust washer which includes camming surfaces for urging said inner and outer anti-extrusion rings into sealing contact with their associated surfaces defined by said bonnet assembly and said access port, respectively.

13. The control device of claim 8 wherein said annular graphite gasket includes camming surfaces associated with said inner and outer anti-extrusion rings and which operate to urge said inner and outer anti-extrusion rings into sealing contact with said bonnet assembly surface and said access port surface, respectively.

14. The control device of claim 13 wherein said camming surfaces include ring retaining segments which operate to maintain said inner and outer extrusion rings in an assembled relation prior to installation.

15. The control device of claim 8 wherein said annular graphite gasket has a density of 0.8 grams of graphite per cubic centimeter or higher.

16. The control device of claim 9 further comprising a cap for overlying said access port and including a plurality of clamping fasteners which extend into engagement with said bonnet assembly and which are operative to apply forces to said bonnet assembly which act to compress said annular graphite gasket, whereby said annular graphite gasket and associated anti-extrusion rings are urged into sealing engagement with said bonnet assembly surfaces and said access port surface.

17. The control device of claim 16 wherein said forces applied to said annular graphite gasket cause plastic flow of said gasket whereby sealing is enhanced, said anti-extrusion rings inhibit the flow of gasket material out of seal assembly cavity.

18. The control device of claim 16 further comprising a retaining ring for said bonnet assembly for maintaining the position of said bonnet assembly within said body portion and a backing ring abutably engageable with said retaining ring, said retaining ring operative to apply compression forces to said annular graphite gasket when said threaded fastener are operated to apply retaining forces to said bonnet assembly.

19. The control device of claim 18 wherein said retaining ring is segmented.

20. The control device of claim 11 wherein said ends of said at least one anti-extrusion ring are shaped to engage each other to form a shiplap joint.
